(19) United States
(12) Patent Application Publication
(10) Pub. No.: US 2008/0106015 A1
(43) Pub. Date: May 8, 2008

(54) ACTIVE VIBRATION REDUCTION SYSTEM

(75) Inventors: Takehiko FUSHIMI, Kariya-shi (JP); Daichi MIZUSHIMA, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN SEIKI KABUSHIKI KAISHA, Kariya-shi (JP)

(21) Appl. No.: 11/934,842

(22) Filed: Nov. 5, 2007

(30) Foreign Application Priority Data
Nov. 8, 2006 (JP) 2006-302832

(51) Int. Cl. F16F 15/03

(52) U.S. Cl. 267/140.15

(57) ABSTRACT

An active vibration reduction system for a vehicle for suppressing a vibration from a vibration source includes a vibration suppression signal generating unit for generating a vibration suppression signal having a frequency being synchronous with the vibration from the vibration source, a sensible signal generating unit for generating a sensible signal having a frequency being asynchronous with the vibration from the vibration source, a magnetic pole forming magnetic flux, a coil provided in a manner that intersects the magnetic flux, and a coil driving circuit relatively vibrating the magnetic pole and the coil by controlling an energized state of the coil based on the vibration suppression signal and the sensible signal.

### CROSS REFERENCE TO RELATED APPLICATIONS

This application is based on and claims priority under 35 U.S.C § 119 with respect to Japanese Patent Application 2006-302832, filed on Nov. 8, 2006, the entire content of which is incorporated herein by reference.

### FIELD OF THE INVENTION

This invention relates to an active vibration reduction system, in particular, the invention relates to an active vibration reduction system which provides vibrations to a vibration source such as a vehicle engine to actively suppress vibrations from the vibration source.

### BACKGROUND

An active vibration reduction system actively suppresses vibrations occurring when an engine, a motor or the like provided at a vehicle vibrates by providing vibrations, which has a substantially opposite phase of the vibrations of a vibration source, and thus improving comfort and quietness in the vehicle. For example, in an active vibration reduction system disclosed in JP 2001-14097A, an electromagnetic actuator (coil) is driven by controlling an H bridge circuit being synchronized with a rotational pulse signal of an engine, i.e. the vibration source, to generate the vibrations. The vibrations from the vibration source are suppressed by a counter-force of the generated vibrations.

In the active vibration reduction system, an enhanced vibration suppression performance is expected for upgrading the quietness of the vehicle. However, it becomes difficult for pedestrians and the like to perceive the approach of the vehicle in exchange for improvement of the vibration suppression performance. In order to resolve the issue, a car horn may be used. However, if the car horn is sounded while the vehicle is being driven in an urban area or a residential area, other issues such as a noise issue may occur.

A need exists for an active vibration suppression system which is not susceptible to the drawback mentioned above.

### SUMMARY OF THE INVENTION

According to an aspect of the present invention, an active vibration reduction system for a vehicle for suppressing a vibration from a vibration source includes a vibration suppression signal generating unit for generating a vibration suppression signal having a frequency being synchronous with the vibration from the vibration source, a sensible signal generating unit for generating a sensible signal having a frequency being asynchronous with the vibration from the vibration source, a magnetic pole forming magnetic flux, a coil provided in a manner that intersects the magnetic flux, and a coil driving circuit relatively vibrating the magnetic pole and the coil by controlling an energized state of the coil based on the vibration suppression signal and the sensible signal.

### BRIEF DESCRIPTION OF THE DRAWINGS

The foregoing and additional features and characteristics of the present invention will become more apparent from the following detailed description considered with reference to the accompanying drawings, wherein:

FIG. 1 is a schematic view illustrating an arrangement of an active vibration reduction system;

FIG. 2 is a schematic view illustrating an entire system of the active vibration reduction system according to a first embodiment of the present invention;

FIG. 3 is a diagram explaining calculation of an estimated time by using moving average method;

FIG. 4 is a diagram showing a signal synthesized from a vibration suppression signal and a sensible signal;

FIG. 5 is an electric circuit diagram showing a coil driving circuit schematically;

FIG. 6 is a table of an amplitude and a phase for generating the vibration suppression signal;

FIG. 7 is a table showing a musical scale data when the sensible signal is in an audible frequency range;

FIG. 8 is a diagram showing data when a melody is used as the sensible signal;

FIG. 9 is a schematic view illustrating an entire system of an active vibration reduction system according to a second embodiment of the present invention; and

FIG. 10 is a flowchart showing steps of vibration suppression performed by the active vibration reduction system according to the present invention.

### DETAILED DESCRIPTION

Hereinafter, embodiments of the present invention will be described with reference to drawings.

### First Embodiment of the Present Invention

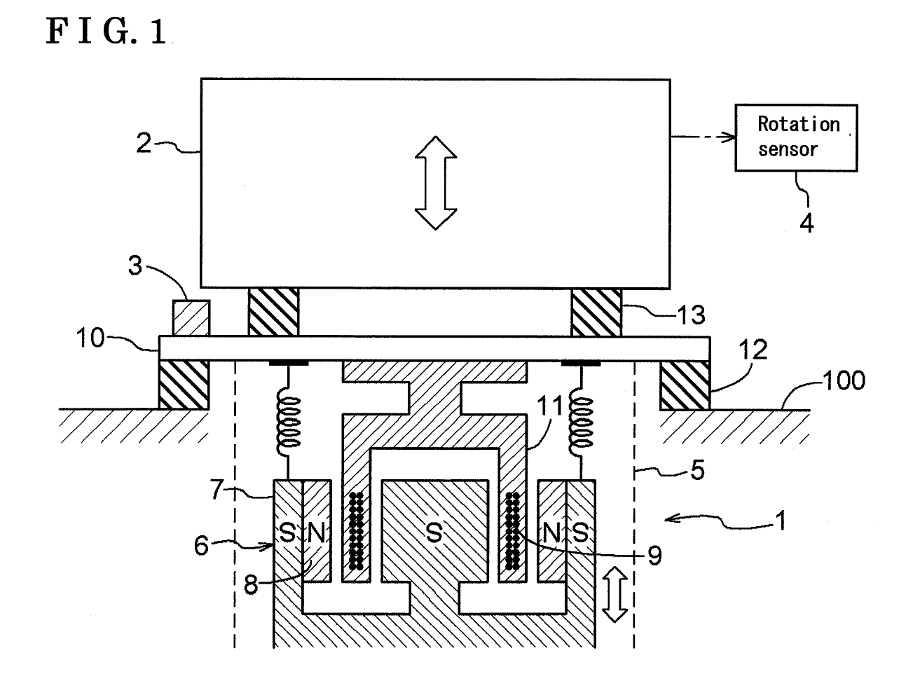

FIG. 1 is a schematic view illustrating an arrangement of an active vibration reduction system 1. The active vibration reduction system 1 according to the embodiments of the present invention is provided with a vibrator 5 for actively suppressing or reducing vibrations of an engine 2, i.e. a vibration source, by providing vibrations to the engine 2 included at a vehicle. The vibrator 5 is provided with a magnetic pole 6 and a coil 9 which is provided thereat so as to intersect magnetic flux formed by the magnetic pole 6.

The magnetic pole 6 is provided with a south pole 7 and north poles 8, and the coil 9 is movably inserted into a cylindrical space defined between the south pole 7 and the north poles 8. The coil 9 is held by a cylindrical coil holding member 11, and the coil holding member 11 is fixed to an engine sub-flame 10 which is provided at a body 100 via rubber mounts 12. Further, the engine 2 is provided via the engine sub-frame 10 and the engine mounts 13. Thus, the magnetic pole 6 is vibrated by the magnetic field formed by flowing current into the coil 9. As just described, the coil 9 is vibrated by a signal having a frequency being synchronous with the vibrations from the engine 2 and thereby suppressing the vibrations from the engine 2.

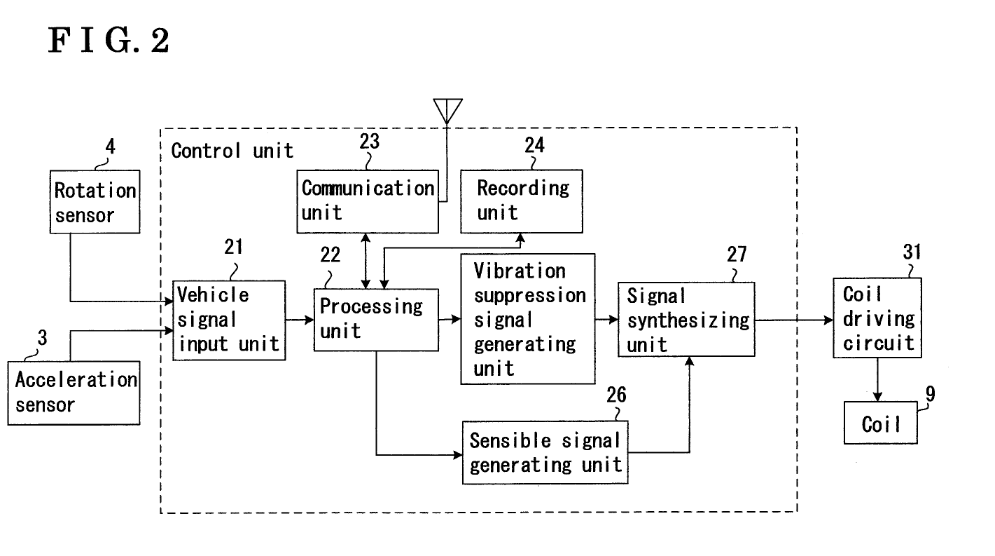

FIG. 2 is a schematic view illustrating an entire system of an active vibration reduction system 1 according to a first embodiment of the present invention. A control unit 20 controlling the active vibration reduction system obtains operational information of the vehicle from an acceleration sensor 3 and a rotation sensor 4 provided at the vehicle. In particular, the engine speed, which is necessary information for the vibration suppression, is identified based on a TACH signal output from the rotation sensor 4. The rotation signal is sequentially input to a vehicle signal input unit 21 included in the control unit 20 to be transmitted to a processing unit 22 while the engine 2 is being in operation. In the processing unit 22, the estimation of the engine speed and the frequency is calculated by using the TACH signal input to the processing unit 22 based on Feed forward theory.

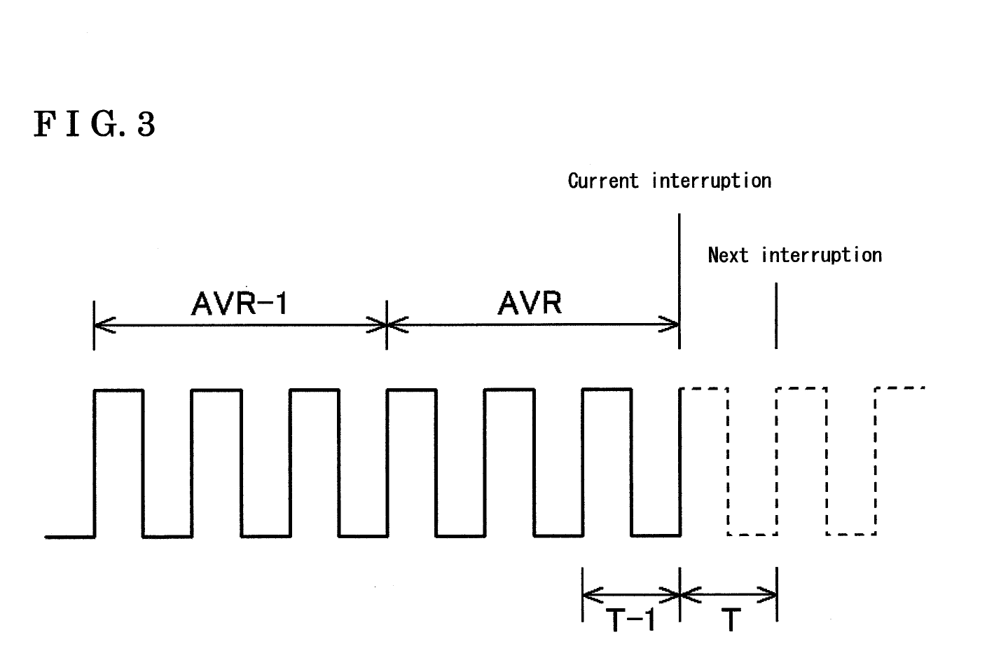

The estimation of the engine speed is calculated by using the moving average method as shown in FIG. 3. Three pulses compose one segment. The average of the segment, from current interruption to three previous pulses, is referred to as AVR and the average of another segment, from AVR to three previous pulses, is referred to as AVR−1. T−1 indicates a time period required for one cycle of the pulse, from the current interruption to the previous pulse, and T indicates an estimated time period from the current interruption to the next interruption. Thus, the estimated time period from the current interruption to the next interruption is calculated as a below-described formula.

T=(AVR/(AVR−1))*(T−1)

Further, the engine speed and the frequency of the engine 2 are determined by the estimated time period. Specifically, assume that AVR−1 is 66 milliseconds, AVR is 60 milliseconds, and T−1 is 20 milliseconds. In this case, T is calculated to be approximately 18.18 milliseconds. Hence, it is estimated that the engine speed of the engine 2 maintained until the next interruption is approximately 1100 rpm and the frequency is 55 Hz. As just described, the engine speed and the frequency are calculated with higher accuracy by using the moving average method based on Feed forward control.

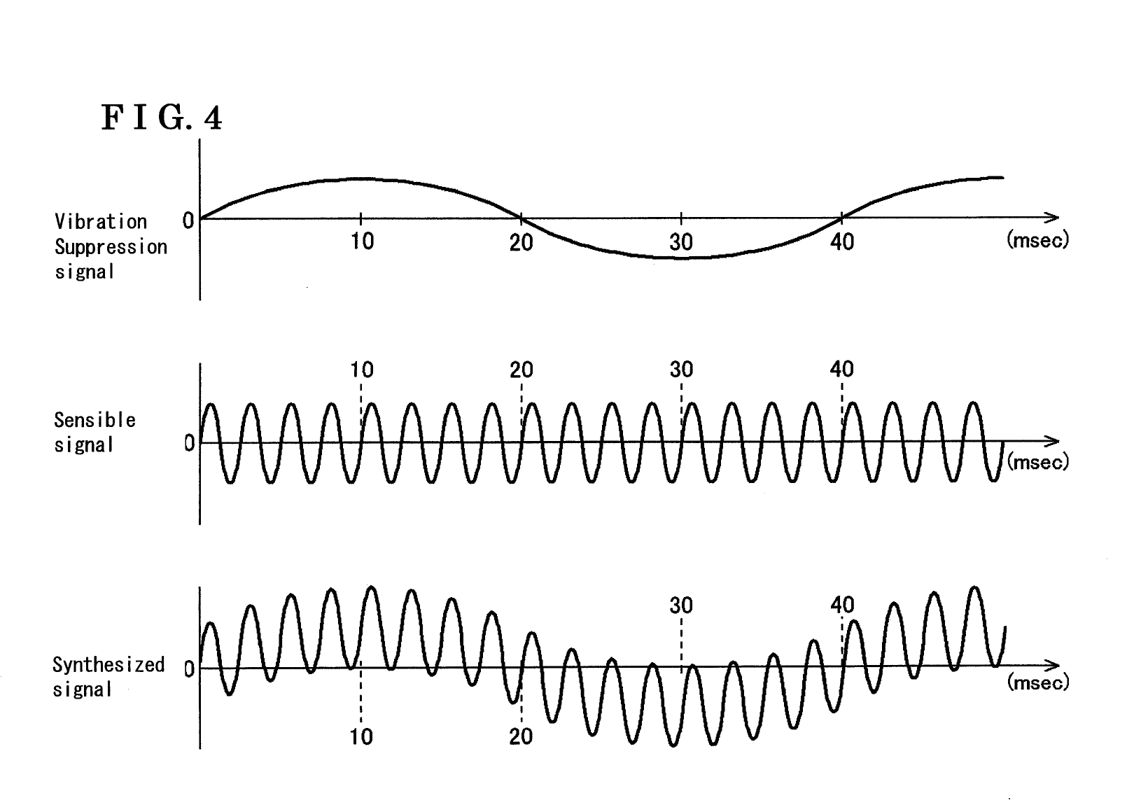

The control unit 20 is provided with a vibration suppression signal generating unit 25, which generates a vibration suppression signal, and a sensible signal generating unit 26 which generates a sensible signal. The frequency analysis is performed based on the engine speed of the engine 2, which is estimated in the processing unit 22 as described above, in the vibration suppression signal generating unit 25 to generate the vibration suppression signal having the frequency synchronized with the vibrations from the engine 2. In the active vibration reduction system according to the embodiments of the present invention, the coil 9, which is provided at the active vibration reduction system 1, is used for generating both the vibration suppression signal and the sensible signal, and the system does not include two separate coils for generating the respective signals. Thus, these signals need to be combined in advance. The signal synthesis is conducted in a signal synthesizing unit 27, and an example of the signal synthesis is shown in FIG. 4. For example, a vibration suppression signal having a frequency of 25 Hz is generated in the vibration suppression signal generating unit 25, and a sensible signal having a frequency of 400 Hz is generated in the sensible signal generating unit 26. Then, a signal is synthesized from the vibration suppression signal having the frequency of 25 Hz and the sensible signal having the frequency of 400 Hz in the signal synthesizing unit 27. As shown in FIG. 4, the signal is synthesized in a manner that the sensible signal is superposed on the vibration suppression signal. Here, the frequencies of 25 Hz and 400 Hz are just examples, and the signals may have other frequencies.

The sensible signal has the frequency being asynchronous with the vibrations from the engine 2. The data of the sensible signal may be created in advance, and the data is stored in a recording unit 24. The processing unit 22 reads in the data from the recording unit 24 as needed to output the data to the sensible signal generating unit 26. Although one kind of the sensible signal, which is stored in the recording unit 24, may be sufficient, but plural kinds of sensible signals may be stored therein. As for the storing process, the data of the sensible signals may be stored in the recording unit 24 during the manufacturing process of the control unit 20. In addition, a communication unit 23 provided at the control unit 20 communicates with external facilities via an antenna, and the signal data may be rewritten and be added in accordance with the user's preference.

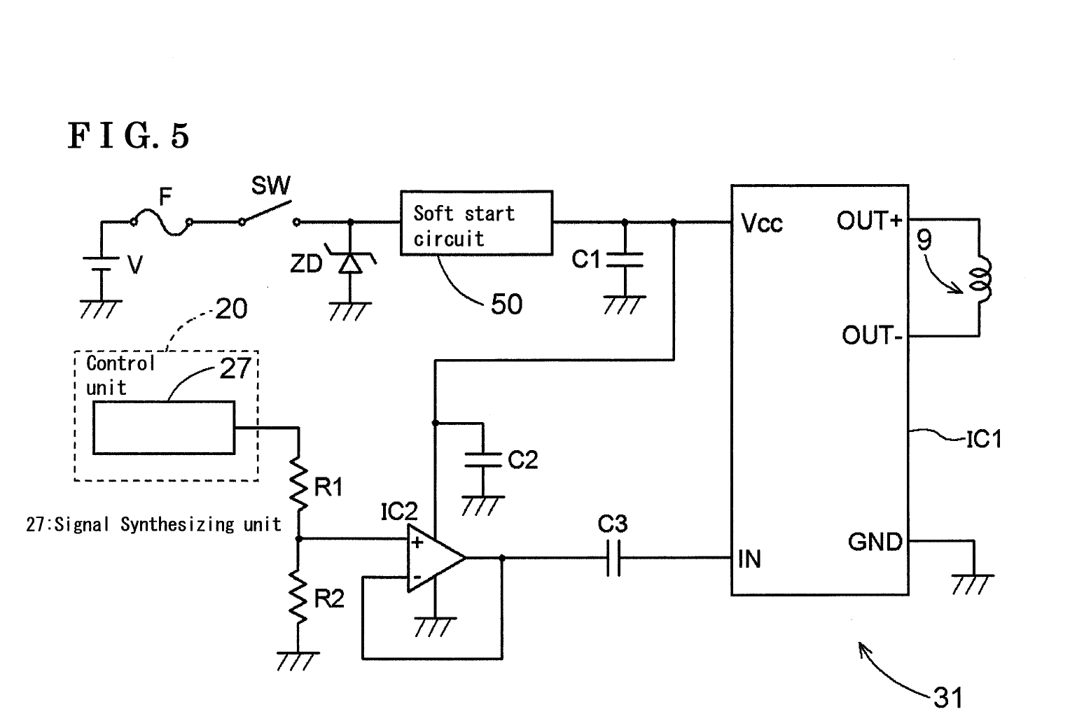

The synthesized signal, which is synthesized in the signal synthesizing unit 27, is input to a coil driving circuit 31. The coil driving circuit 31 controls an energized state of the coil 9 provided at the active vibration reduction system 1. FIG. 5 schematically shows an electrical circuit diagram of the coil driving circuit 31. Power is supplied to the coil driving circuit 31 from a power source V such as a battery provided at the vehicle, and the coil driving circuit 31 is provided with a fuse F and a switch SW at an input stage. The fuse F protects the circuit from excessive current and the switch SW controls the operation of the coil driving circuit 31. A zener diode ZD is provided at a subsequent stage of the switch SW to protect the coil driving circuit 31 from the surge voltage, and a soft start circuit 50 is further provided at the coil driving circuit 31. The soft start circuit 50 prevents the fuse F from fusion cutting due to an excessive inrush current to an input capacitor C1 or prevents the power source V from overloading. However, the fuse F, the zener diode ZD, the soft start circuit 50, and the like are not essential in the active vibration reduction system according to the embodiments of the invention, and the coil driving circuit 31 may be structured without these components. Further, other components may be adopted in the active vibration reduction system to satisfy each function. A controller IC1 is disposed at the subsequent stage of the soft start circuit 50 to control the current flowing into the coil 9.

Meanwhile, an amplitude value of the synthesized signal output from the signal synthesizing unit 27 is converted by a register R1 and a register R2 to be input to a buffer IC2. The output of the buffer IC2 is input to the controller IC1 via a coupling capacitor C3. The controller IC1 controls the current flowing into the coil 9 in accordance with the synthesized signal and thereby vibrating the magnetic pole 6 and the coil 9 relatively. In FIG. 5, the controller IC1 is composed by five terminals. However, terminals for a feedback signal may be provided to stabilize the control of the current flowing into the coil 9. Further, the vibrations may be generated by controlling the voltage, instead of the current.

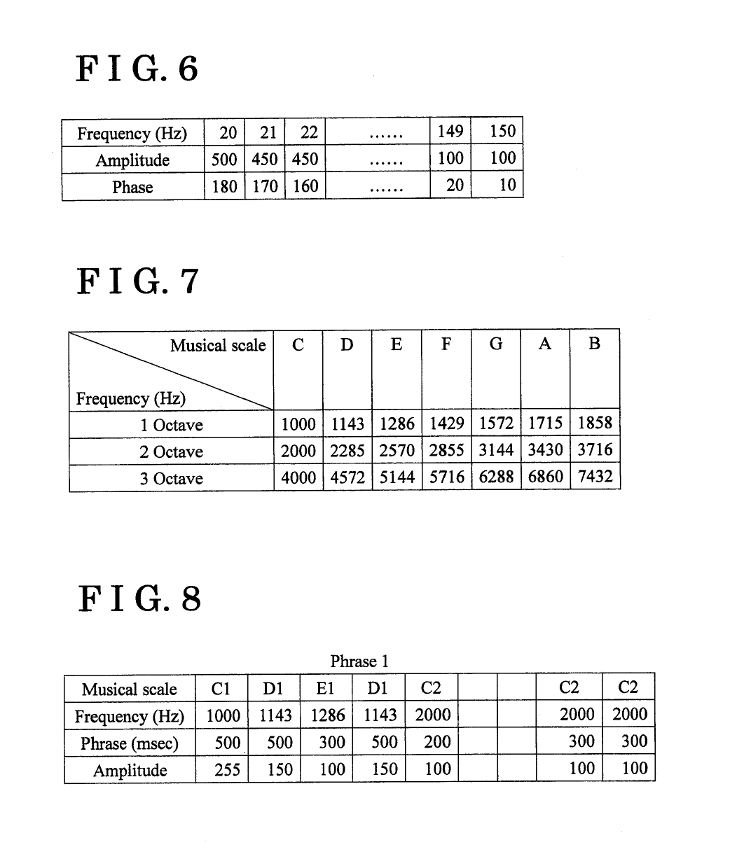

FIG. 6 shows a table of the amplitude and the phase for generating the vibration suppression signal. As described above, the estimation of the engine speed of the engine 2 is calculated based on Feed forward control in the active vibration reduction system according to the embodiments of the invention. The frequency analysis is performed using the estimation. Then, the amplitude and the phase, corresponding to the frequency obtained by the analysis, are selected to suitably suppress the vibrations from the engine 2, and the vibration suppression signal is generated referring to the amplitude and the phase. More specifically, in the case that the frequency is determined to be 20 Hz in the frequency analysis, the vibration suppression signal is generated so as to have a property of the amplitude being 500 and the phase being 180. On the other hand, in the case that the frequency is 22 Hz, the vibration suppression signal is generated so as to have a property of the amplitude being 450 and the phase being 160.

FIG. 7 shows a musical scale data used when the sensible signal is a signal in an audible frequency range, i.e. sound. The estimated frequency used for the generating vibration suppression signal is multiplied by a predetermined number set by the user, and the sound corresponding to the multiplied frequency is generated by the sensible signal generating unit 26. For example, the estimated frequency of the vibration suppression signal is 125 Hz and the multiplied number is set to 8, the sensible signal is generated based on the data of C in octave 1, which corresponds to 1000 Hz. Thus, the vibration suppression signal and the sensible signal are combined as described above to energize the coil 9, and thereby generating the sound while suppressing the vibrations of the engine 2. Therefore, the vehicle alerts the pedestrians and the like of the approach of the vehicle without using the car horn in the urban area.

FIG. 8 shows an example of the data when the sensible signal is generated as a melody having a predetermined phrase playing time. When an electric-hybrid vehicle and the like are run by a motor, the vibrations are hardly transmitted from the engine 2. Thus, the vibration suppression signal may be terminated, and the coil 9 may be energized based on the sensible signal alone. In this case, the melody is played based on the data shown in FIG. 8, thereby alerting the pedestrians and the like of the approach of the vehicle without using the car horn when the electric-hybrid vehicle is running in the urban area.

### Second Embodiment of the Present Invention

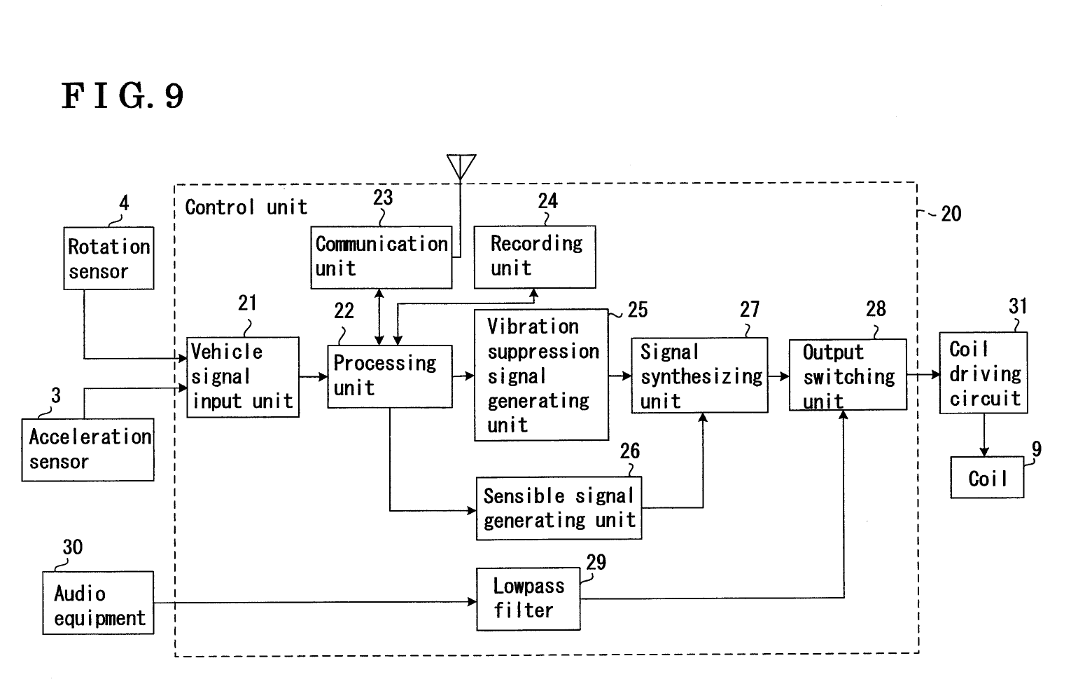

FIG. 9 is a schematic view showing an entire system of an active vibration reduction system according to a second embodiment of the present invention. The system is different from that of the first embodiment in that an output switching unit 28, a lowpass filter 29, and an audio equipment 30 are provided thereat. In the second embodiment, the coil 9, which is provided at the active vibration reduction system 1, may be vibrated based on an audio signal of the audio equipment 30 provided at an exterior portion of the system. In this case, the audio signal is transmitted from the audio equipment 30 to the coil driving circuit 31 via the lowpass filter 29. Before the audio signal is transmitted to the coil driving circuit 31, the synthesized signal, which is synthesized in the signal synthesizing unit 27, is switched to the audio signal in the output switching unit 28. So configured, the coil 9 provided at the active vibration reduction system 1 is vibrated based on the audio signal and thereby obtaining woofer and subwoofer functions without additionally disposing a woofer and a subwoofer to the system.

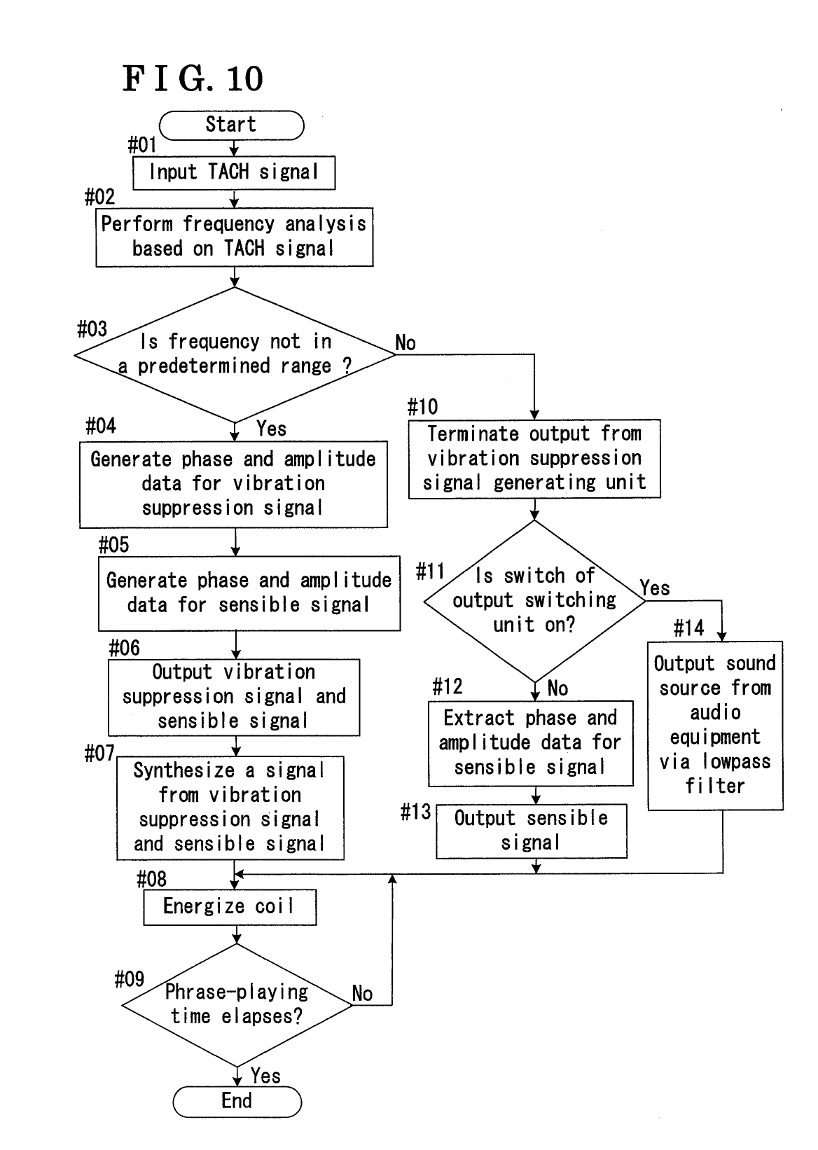

The first and second embodiments are described referring to a flowchart. FIG. 10 is a flowchart showing steps of the vibration suppression conducted by the active vibration reduction system according to the embodiments of the invention. When the engine 2 starts, the rotation sensor 4 outputs the TACH signal based on the engine speed of the engine 2. The TACH signal is input to the vehicle signal input unit 21 (Step #01), and the processing unit 22 calculates the estimation of the engine speed by using the moving average method based on Feed forward theory. Thus, the engine speed is identified with high accuracy. The frequency is determined based on the estimated engine speed (Step #02).

If the frequency falls out of a predetermined frequency range, that is, when the engine speed is slow as in an idling state and the frequency is low, or when the engine speed is high as in an acceleration state and the frequency is high (Step #03:Yes), the vibration suppression signal generating unit 25 reads the phase and amplitude data, which corresponds to the determined frequency, from the amplitude and phase table to generate the vibration suppression signal (Step #04). Next, the sensible signal generating unit 26 reads the music scale data stored in the recording unit 24 to generate the sensible signal based on the music scale data (Step #05).

The vibration suppression signal generating unit 25 and the sensible signal generating unit 26 output the vibration suppression signal and the sensible signal respectively to the signal synthesizing unit 27 (Step #06). The signal synthesizing unit 27 generates the synthesized signal based on the respective signals (Step# 07), and the coil 9 is energized by the coil driving circuit 31 (Step #08). The energization of the coil 9 continues until the phrase playing time elapses (Step #09:No). When the phrase playing time elapses, the energization of the coil 9 is terminated (Step #09:Yes).

If the frequency, which is calculated using the TACH signal, is in the predetermined frequency range, for example, when the vehicle is running on a highway or when the electric-hybrid vehicle is driven by the motor (Step #03:No), the output of the vibration suppression signal generating unit 25 is terminated because the vibrations from the engine 2 is imperceptible (Step #10). If the switch of the output switching unit 28 is not on (Step #11:NO), the sensible signal generating unit 26 reads the melody registered in a melody table stored in the recording unit 24 to generate the sensible signal (Step #12). At this time, the output from the vibration suppression signal generating unit 25 is terminated, and thus the sensible signal is output to the coil driving circuit 31 without being combined with the vibration suppression signal (Step #13) and the coil 9 is energized (Step #08). The energization of the coil 9 continues until the phrase playing time elapses (Step #9:No). When the phrase playing time elapses, the energization of the coil 9 is terminated (Step #9:Yes).

On the other hand, if the switch of the output switching unit 28 is on (Step #11:Yes), the sound source is output from the audio equipment 30 to the coil driving circuit 31 via the lowpass filter 29 (Step #14). The coil 9 is energized by the coil driving circuit 31 based on the signal of the sound source (Step #08). The energization of the coil 9 continues until the phrase playing time elapses (Step #09:NO). When the phrase playing time elapses, the energization of the coil 9 is terminated (Step #09:Yes).

### Other Embodiments

In the aforementioned embodiments, each component of the control unit 20 is described. These components may be mounted on a chip by employing a microcomputer and an ASIC (Application Specific Integrated Circuit). Further, the control unit 20 and the coil driving circuit 31 may be mounted on one chip. So configured, the size of the active vibration reduction system is reduced and thus enabling the system to save space.

In the aforementioned embodiments, the signal in the audible frequency range is used as the sensible signal. However, the sensible signal is not limited to this kind of signal. For example, the sensible signal may be used as a warning signal in case that the driver falls asleep at the wheel, and vibrations are generated to wake up the driver.

In the first embodiment, the sensible signal is generated by multiplying the vibration suppression signal by 8, but the number of times is not limited to 8. The number of times may be set to any number.

In the first embodiment, the sensible signal is stored in the recording unit 24 or may be rewritten or added by the communication unit 23 which communicates with the external facilities via the antenna. However, the sensible signal is not limited to these examples. For instance, the vehicle may communicate with a predetermined base station or other systems by using CAN (Controller Area Network) to alert the driver about abnormality of the vehicle or road construction by melodies.

In the second embodiment, the synthesized signal, which is synthesized from the vibration suppression signal and the sensible signal, and the audio signal input from the audio equipment are switched in the output switching unit 28 to transmit the signal to the coil driving circuit 31. However, the transmission of the audio signal is not limited to the above-described example. A signal may be synthesized from the vibration suppression signal and the audio signal to be transmitted to the coil driving circuit 31. Further, the vibrations may be suppressed based on the audio signal alone.

The structure of the active vibration reduction system 1 allows the vibration suppression signal to suppress the vibrations from the vibration source. In addition, a signal having a frequency being asynchronous with the vibrations from the vibration source is synthesized, and the coil 9 is vibrated based on the synthesized signal. Thus, the sensible signal is output while suppressing the vibrations from the vibration source.

According to the above-described structure of the active vibration reduction system 1, the sensible signal may be in the audible frequency range. Further, the signal generated based on the sensible signal may serve as a warning device. This structure allows the vehicle to run in the urban area and the residential area playing the music, and thereby alerting the pedestrians of the approach of the vehicle without sounding the car horn. Thus, accidents, possibly leading to physical injuries, become avoidable.

According to the above-described structure of the active vibration reduction system 1, the audio signal transmitted from the audio equipment 30 via the lowpass filter 29 may be used as the sensible signal, and the magnetic pole 6 and the coil 9 are relatively vibrated based on the audio signal.

The structure allows the user to use the audio signal from the exterior portion of the system as the sound source. Thus, melodies are sounded without adding new speakers. Further, since the audio signal is transmitted via the lowpass filter 29, the speaker function is preformed stressing bass sounds. Therefore, a surround-sound system, which stresses the bass sounds, is built.

The principles, of the preferred embodiments and mode of operation of the present invention have been described in the foregoing specification. However, the invention, which is intended to be protected, is not to be construed as limited to the particular embodiment disclosed. Further, the embodiment described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. An active vibration reduction system for a vehicle for suppressing a vibration from a vibration source, comprising:
a vibration suppression signal generating unit for generating a vibration suppression signal having a frequency being synchronous with the vibration from the vibration source;
a sensible signal generating unit for generating a sensible signal having a frequency being asynchronous with the vibration from the vibration source;
a magnetic pole forming magnetic flux;
a coil provided in a manner that intersects the magnetic flux; and
a coil driving circuit relatively vibrating the magnetic pole and the coil by controlling an energized state of the coil based on the vibration suppression signal and the sensible signal.

2. An active vibration reduction system according to claim 1, wherein the sensible signal is a signal in an audible frequency range.

3. An active vibration reduction system according to claim 1, wherein the signal generated based on the sensible signal serves as a warning device.

4. An active vibration reduction system according to claim 2, wherein the signal generated based on the sensible signal serves as a warning device.

5. An active vibration reduction system according to claim 1, wherein the sensible signal is an audio signal transmitted from an audio equipment via a lowpass filter, and the coil and the magnetic pole are relatively vibrated based on the audio signal.

6. An active vibration reduction system according to claim 2, wherein the sensible signal is an audio signal transmitted from an audio equipment via a lowpass filter, and the coil and the magnetic pole are relatively vibrated based on the audio signal.
